(19) United States
(12) Patent Application Publication
(10) Pub. No.: US 2011/0071929 A1
(43) Pub. Date: Mar. 24, 2011

(54) SYSTEMS AND METHODS FOR MANAGING BUILDING SERVICES

(75) Inventor: John David Morrison, New South Wales (AU)

(73) Assignee: HONEYWELL INTERNATIONAL INC., Morristown, NJ (US)

(21) Appl. No.: 12/864,818

(22) PCT Filed: Feb. 3, 2009
(86) PCT No.: PCT/AU2009/000124

§ 371 Date: Nov. 1, 2010

(30) Foreign Application Priority Data
Jan. 30, 2008 (AU) 2008900408

(51) Int. Cl. G06Q 10/00

(52) U.S. Cl. 705/30

(57) ABSTRACT

Described herein are systems and methods for managing building services. In overview, various embodiments provide software, hardware and methodologies underlying an approach to the management of building services as discussed herein. Generally speaking, data collected at an access control terminal is processed to determine building service costs, and appropriately attribute those costs to a relevant party or group of parties. In one example, a building has a conference room that is available for use by a plurality of tenants. To use the meeting room, an employee of one of the tenants provides an access control respective token to an access control terminal located in a conference room. This initiates a request, which is subsequently either granted or denied subject to an authorization/authentication procedure. Where the request is granted, the user is provided with access to a building service essentially defining usage of the conference room for a predetermined period of time. For example, lighting and air-conditioning is provided to the room for that predetermined period. A building service cost associated with that usage of the conference room is determined (for example in terms of power, maintenance, etc), and attributed to the relevant tenant.

### FIELD OF THE INVENTION

The present invention relates to systems and methods for managing building services. Embodiments of the invention have been particularly developed for tracking usage of building resources by leveraging access control technologies. While some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

In a building that houses multiple parties, a variety of services that are provided by the building are shared be the parties. Such services include the likes of conference rooms, elevators, security/surveillance, and so on. There is an inherent cost involved in providing these services, which should be apportioned in some manner between the parties. Traditionally, this apportionment occurs in advance based on anticipated usage characteristics, which in turn are based on objective factors such as, for example, the amount of floor space occupied by the party. However, it will be appreciated that anticipated usage characteristics do not necessarily align with actual usage characteristics. This may lead to substantial inequalities whereby, for two parties having similar presences with a building (in terms for floor space, for instance), one makes significantly more use of a given building service than the other, although costs are apportioned similarly.

Equality favors an approach whereby apportionment is based on actual usage characteristics, for example on a “user pays” basis. However, there are significant practical difficulties in implementing such an approach, and the costs are generally seen to outweigh the perceived benefits.

There is a need in the art for improved systems and methods for managing building services.

### SUMMARY OF THE INVENTION

It is an object of the present invention to overcome or ameliorate at least one of the disadvantages of the prior art, or to provide a useful alternative.

One embodiment provided a method for managing building services, the method including the steps of:

(a) receiving input data indicative of a request granted at an access control terminal;

(b) processing the input data to determine a building service cost for the granted request; and

(c) attributing the building service cost to a party associated with the granted request.

One embodiment provides a method for providing a building service, the method including the steps of:

(a) receiving a request indicative of an access control token;

(b) subject to performing an authentication/authorisation procedure, selectively to granting the request; and

(c) in the case that the request is granted:
i. providing a first signal for providing access to the building service; and
ii. providing a second signal for allowing the attribution of a building service cost for the building service.

One embodiment provides an access control terminal for selectively granting access to a building service, the terminal including:

an input for reading data from an access control token;

a processor for performing an authentication/authorisation procedure to determine whether the request is to be granted;

a first output for providing a first signal for granting access to the building service in the case that the request is granted;

a second output for providing a second signal for allowing the attribution of a building service cost for the building service in the case that the request is granted.

One embodiment provides a method for attributing the costs of shared building resources for a building between a plurality of user groups, the method including the steps of:

installing a plurality of access control devices at locations within the building;

configuring the access control devices for controlling access to respective shared building resources, wherein the access is functional rather than physical;

receiving, at the access control devices, data indicative of access requests, wherein each access request is indicative of a user group identifier for allowing identification of a user group to which a given access request is attributable;

processing each access request for respectively selectively granting an instance of access to the relevant shared building resource;

maintaining a database including data indicative of instances of access to the shared building resources, wherein each instance of access is associated with the user group identifier for the causal access request; and

on the basis of the data indicative of instances of access to the shared building resources and the associated user group identifiers, attributing the costs of the shared building resources between the plurality of user groups.

One embodiment provides a computer implemented method for attributing the costs of shared building resources for a building between a plurality of user groups for that building, the method including the steps of

maintaining data indicative of the configuration of a plurality of access control devices, wherein each access control device is configured for controlling access to a respective shared building resource, wherein the access is functional rather than physical;

receiving, from the access control devices, data indicative of instances of access to the shared building resources, wherein each instance of access is able to be associated with a user group identifier for the causal access request for allowing identification of a user group to which a given access request is attributable; and

on the basis of the data indicative of instances of access to the shared building resources and the associated user group identifiers, attributing the costs of the shared building resources between the plurality of user groups.

One embodiment provides a system for attributing the costs of shared building resources for a building between a plurality of user groups for that building, the system including:

a plurality of access control devices installed at locations within the building, wherein the access control devices are configured for controlling access to respective shared building resources, wherein the access is functional rather than physical, wherein controlling access to respective shared building resources includes, for a given device:
receiving, at the access control devices, data indicative of an access request, wherein the access request is indicative of a user group identifier for allowing identification of a user group to which the access request is attributable; and
in response to the access request, selectively granting an instance of access to the relevant shared building resource;

a database for maintaining data indicative of instances of access to the shared building resources, wherein each instance of access is associated with a user group identifier for the causal access request; and

a computer system for, on the basis of the data indicative of instances of access to the shared building resources and the associated user group identifiers, attributing the costs of the shared building resources between the plurality of user groups.

One embodiment provides an access control device configured for attributing the costs of a shared building resource for a building between a plurality of user groups for that building, the device including:

an input for receiving, at the access control devices, data indicative of access requests, wherein each access request is indicative of a user group identifier for allowing identification of a user group to which a given access request is attributable;

a processor for processing each access request for respectively selectively granting an instance of access to a controlled functionality, wherein the controlled functionality provides access to a shared building resource, wherein the access is functional rather than physical;

a first output that, upon the granting of an instance of access, communicates a signal for providing access to a shared building resource;

a second output for providing to a central location indicative of instances of access to the shared building resources, wherein each instance of access is associated with a user group identifier for the causal access request, such that on the basis of the data indicative of instances of access to the shared building resources and the associated user group identifiers, the costs of the shared building resources are able to be attributed between the plurality of user groups.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

### BRIEF DESCRIPTION OF THE DRAWINGS

Preferred embodiments of the invention will now be described, by way of example only, with reference to the accompanying drawings in which:

FIG. 1 is a schematic representation of a method according to one embodiment.

FIG. 2 is a schematic representation of a device according to one embodiment.

FIG. 3A is a schematic representation of a method according to one embodiment.

FIG. 3B is a schematic representation of a method according to one embodiment.

FIG. 3C is a schematic representation of a method according to one embodiment.

FIG. 4 is a schematic representation of a system according to one embodiment.

FIG. 5A is a schematic representation of a method according to one embodiment.

FIG. 5B is a schematic representation of a method according to one embodiment.

FIG. 5C is a schematic representation of a method according to one embodiment.

FIG. 5D is a schematic representation of a method according to one embodiment.

FIG. 5E is a schematic representation of a method according to one embodiment.

### DETAILED DESCRIPTION

Described herein are systems and methods for managing building services. In overview, various embodiments provide software, hardware and methodologies underlying an approach to the management of building services as discussed herein. Generally speaking, data collected at an access control terminal is processed to determine building service costs, and appropriately attribute those costs to a relevant party or group of parties. In one example, a building has a conference room that is available for use by a plurality of tenants. To use the meeting room, an employee of one of the tenants provides an access control token to an access control terminal located in a conference room. This initiates a request, which is subsequently either granted or denied subject to an authorization/authentication procedure. Where the request is granted, the user is provided with access to a building service essentially defining usage of the conference room for a predetermined period of time. For example, lighting and air-conditioning is provided to the room for that predetermined period. A building service cost associated with that usage of the conference room is determined (for example in terms of power, maintenance, etc), and attributed to the relevant tenant.

### General Method

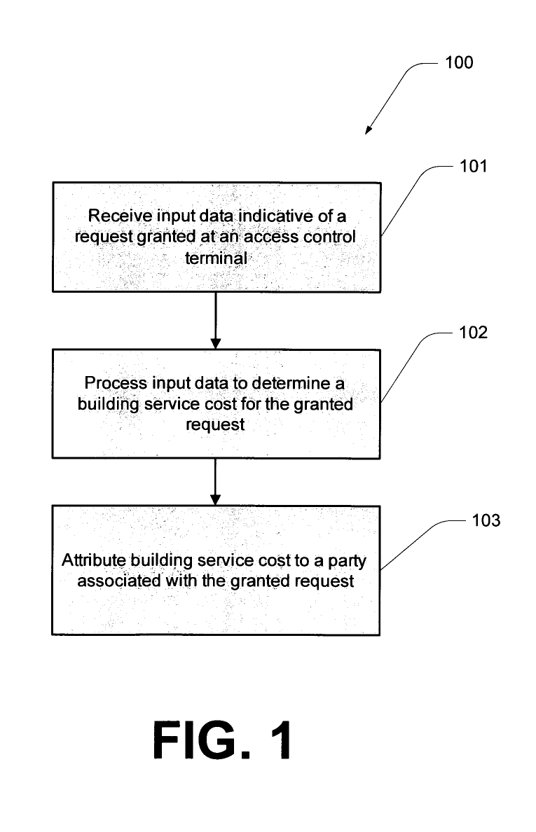

FIG. 1 illustrates a method of managing building services according to one embodiment, in the form of method 100. Step 101 includes receiving input data indicative of a request granted at an access control terminal. For example, a user presents an access control token to an access control terminal, this essentially defining the placement of the request. The request is subjected to an authorization/authentication procedure, and either granted or denied as a result. In the case of a granted request, the input data is defined and transmitted to a computer system responsible for performing method 100.

Step 102 includes processing the input data to determine a building service cost for the granted request. This is discussed in further detail below, although for the time being it is noted that the processing in question often includes identifying certain characteristics of the access control terminal (for example based on a Terminal ID), and on the basis of those characteristics identified one or more building resources to which access has been granted. A query is then submitted to a database to obtain building service cost information for the identified resource or resources.

Although various embodiments herein deal with the notion of “cost” in a financial sense, further embodiments are concerned with other varieties of “cost”. A particular example of this is environmental cost, relating to the environmental impact of a particular request. For example, the environmental impact may be estimated in terms of predicted carbon dioxide emission, and quantified in terms of a carbon credit scheme or the like. Such an approach is optionally implemented to provide carbon footprint accountability across a building, organization, or in a broader context. Such an approach is also optionally implemented in the context of a “cap and trade” or other emissions management scheme.

Step 103 includes attributing the building service cost to a party associated with the granted request. This allows for accounting to be performed such that various approaches may be implemented to align the apportionment of building service costs between multiple parties in a manner that is aligned with the relative usage characteristics for those parties. For example, various services are able to be charged out to the parties on a user-pays basis. In some embodiments a pre-paid credit system is implemented such that additional charges are levied only where usage exceeds anticipated/agreed levels.

The examples provided herein generally involve a “building”, “parties”, and “users”. The term “building” is used generally to describe a physical location or group of locations. In this manner, the term should not read in a limiting manner to describe a single discrete structure, and might include a plurality of distributed structures. For example, in one embodiment the term “building” described a plurality of structures within a university campus. A building is, in a practical sense, used by a plurality of parties. For example, in various embodiments parties include the likes of tenants in a building, departments within a building/organization, non-tenant entities that make use of a building, and/or individual users. From a back-end perspective, a party is defined by group of individual users (or a single individual user, in which case user and party are effectively synonymous). For the sake of the present examples, each user is defined in a database by way of respective User ID.

The term “building services” as used herein should be afforded a broad interpretation. Under the wider gamut of building services come:

Facility-based services. A facility-based service involves the use of a physical resource, such as a location or item of equipment, which is in some cases available for use by multiple parties. Examples include the likes of conference rooms, parking spaces, AV equipment, and so on. The manner by which costing is implemented for such services in some embodiments includes the application of a facility usage fee, which is in broad terms similar to a rental fee. In some embodiments a predetermined facility usage fee is set for the use of a particular physical resource for a set period of time. For example, a facility usage fee of $A is set for the use of a use of an LCD projector for a ½ day period, or a usage fee of $B is set for the use of a conference room for a one-hour period.

Off-peak shared services. In the context of some buildings, some services are made available during off-peak times. For example, in the context of an office building for which business is generally conducted on weekdays, certain services are available on weekends. In some embodiments, the costing for such services takes into account an opportunity cost and a usage cost. In particular, each party incurs a first cost component for the opportunity to use off-peak shared services (this is objectively defined) and a second cost component based on actual usage of off-peak shared services (this is subjectively defined based on method 100).

Utility services. These are building services that involve the use of a utility, such as power/gas/water. In some embodiments these are quantified in units. For example, a certain activity is determined to consume a certain number of utility service units, which have a predetermined cost. For example, powering the lighting in a certain room for X minutes might be determined to consume Y utility service units, having a predetermined cost of $Z.

Consumer services. These are services used by consumers in a traditional user-pays manner. Common examples include the sale of goods and/or services at a vending machine or retail venue. In such cases, the cost of the consumer service is defined by the price of goods and/or services purchased.

It will be appreciated that the above examples are intended to provide some broad categories, and should not be considered as presenting an exhaustive list. Often, a particular building service includes components from more than one of these categories. For example, many practically defined services include both a facility-based service and a utility service, or an off-peak shared service and a utility service.

In some embodiments utility services are absorbed into other services, such as facility services or off-peak shared services. For example, in one embodiment a facility-based service is defined by the use of a meeting room for a one-hour period. Costing for this service takes into account consumption of utility service units. In some embodiments only the utility service units are considered (i.e. there is no specific facility usage fee).

Various embodiments described herein leverage an existing access control system to manage cost implications associated with various building services. It will be appreciated, form the disclosure herein, that significant advantages stem from such an approach. For example, in the context of many buildings, the necessary hardware infrastructure is already in place, and providing an embodiment and described herein is primarily a matter of providing appropriate back-end software to process information generated by the existing hardware such that method 100 (or a variant thereof) is able to be performed.

### Terminal Level Functionality

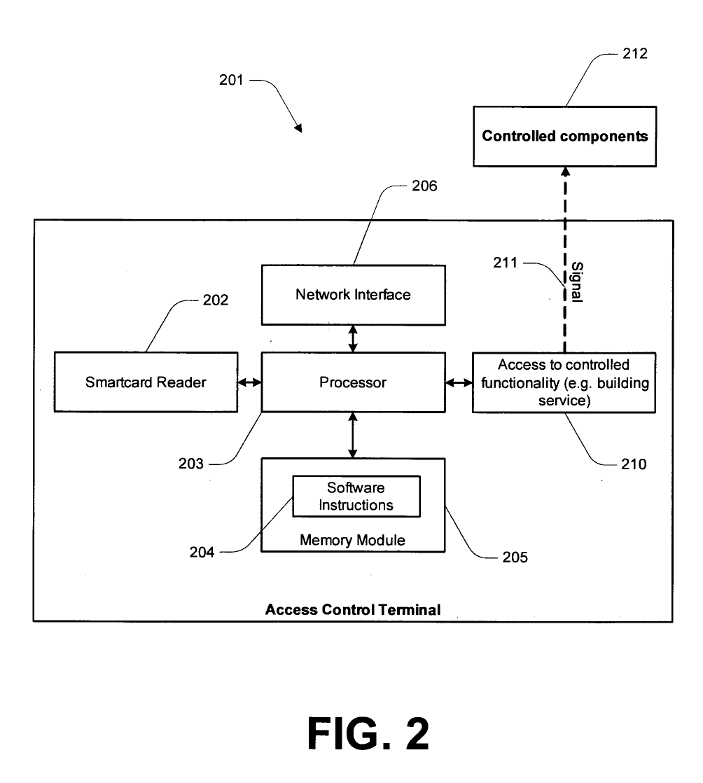

As noted above, step 101 includes receiving input data indicative of a request at an access control terminal. The term “access control terminal” should not be read to imply that the terminal controls access to a physical location (such as an access control device for selectively unlocking a door). Rather, the term is used to describe the manner by which a request is processed. The term “access control terminal” refers to a device that is configured for receiving from an access control token data indicative of a request, and processing that request by way of an authorization/authentication procedure to determine whether it should be granted or denied. In the case that a request is granted, access is granted to a controlled functionality. FIG. 2 illustrates an exemplary access control terminal 201 along such lines, and is discussed in more detail below.

Terminal 201 includes an input 202 for receiving, from an access control token, data indicative of a request. The nature of input 202 depends specifically on the nature of the access control token, and more generally on the nature of a wider access control environment implemented for a particular building. In the present embodiment, input 202 includes a smartcard reader for reading data from a complementary smartcard. The smartcard in question carries the access control token, and is configured to hold data indicative of user credentials, privileges, rights, stored value, transaction histories, and other information. It will be appreciated that the example of such a smartcard arrangement is provided for the sake of example only, and that in other embodiments input 202 is of a different form. For example, in some embodiments input 202 includes:

A proximity card reader for reading data from a complementary proximity card, for example a card carrying an RFID chip.

A swipe card reader for reading data from a complementary swipe card, for example a card carrying a magnetic strip.

A biometric sensor for reading biometric information.

A keypad for receiving numeric or alphanumeric data.

It will be appreciated that a significant advantage of a smartcard stems from read/write functionalities. That is, unlike many other forms of access control token, a smartcard is able to not only carry information for reading by an access control device, it is also able to have additional information written to it (or have existing information modified) by an access control device. Read/write functionalities are leveraged in various embodiments. For example, read/write functionalities are particularly useful for the issuance of smartcards. In one embodiment, smartcards are issued at distributed locations based on a secure communication between the issuing hardware device and a remote server via a flexible web portal.

Terminal 201 includes a processor 203 for executing software instructions 204 maintained on a memory module 205. These software instructions facilitate the authentication/authorization process that is determines whether or not a particular request is to be granted. In some embodiments information relevant to this process is provided by a central server.

Terminal 201 additionally includes a communications interface 206 for allowing communication between terminal 201 and a central server (not shown). The nature of the communications interface varies between embodiments, and may include a wired/wireless Ethernet interface, or a telecommunications module. In the present embodiment terminal 201 is enabled to operate in a connected mode (where there is a connection to the central server) and a disconnected mode (where there is no connection to the central server). Examples provided below deal primarily with the connected mode, and it will be appreciated that various approaches exist for handling data transfer between disconnected readers and the central server, optionally involving the use of connected readers. For example, in one embodiment data maintained at a disconnected terminal is automatically and transparently written to a smartcard, and subsequently passed to the central server when that smartcard is read by a connected terminal.

As foreshadowed, terminal 201 provides access to a controlled functionality in the event that a request is granted. In the context of FIG. 2, this access to a controlled functionality is represented by reference numeral 210. Where access is granted, a signal 211 is provided to the relevant physical components 212 (or typically to one or more control devices responsible for the operation of those components). The nature of the controlled functionality varies between embodiments. For example, they might provide access through a passageway (as in the case of conventional access control devices), allow a transaction to be settled by way of smartcard payment, enable lighting, air conditioning, etc. in a room, provide access to a computing terminal, and so on.

Generally speaking, for the sake of the present embodiments, a terminal 201 is integrated into any building service dispensing point, and the controlled functionality defines a building service. A user provides his/her smartcard to the dispensing point to request access to the service, and this request is subsequently either granted or denied.

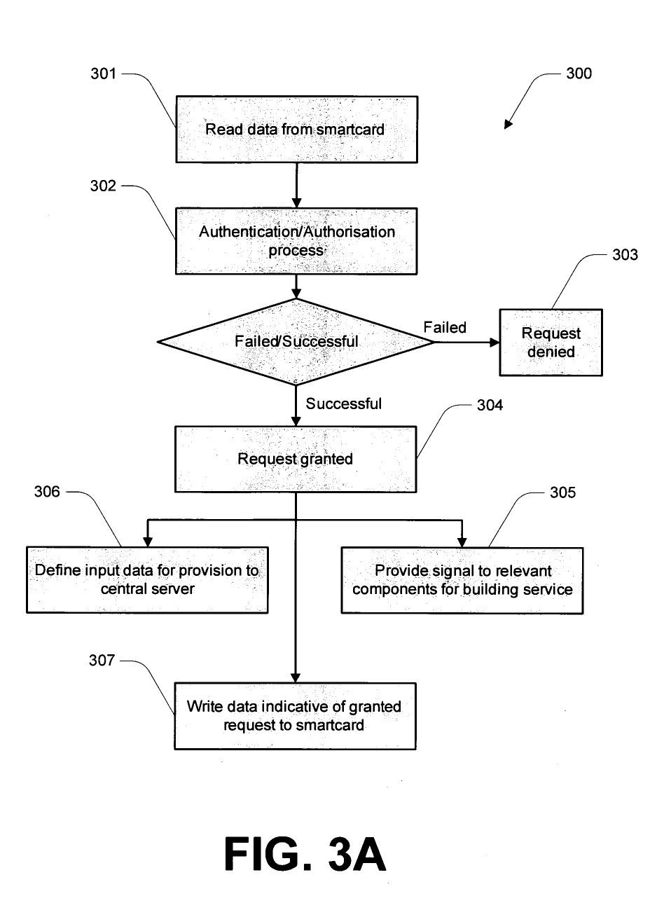

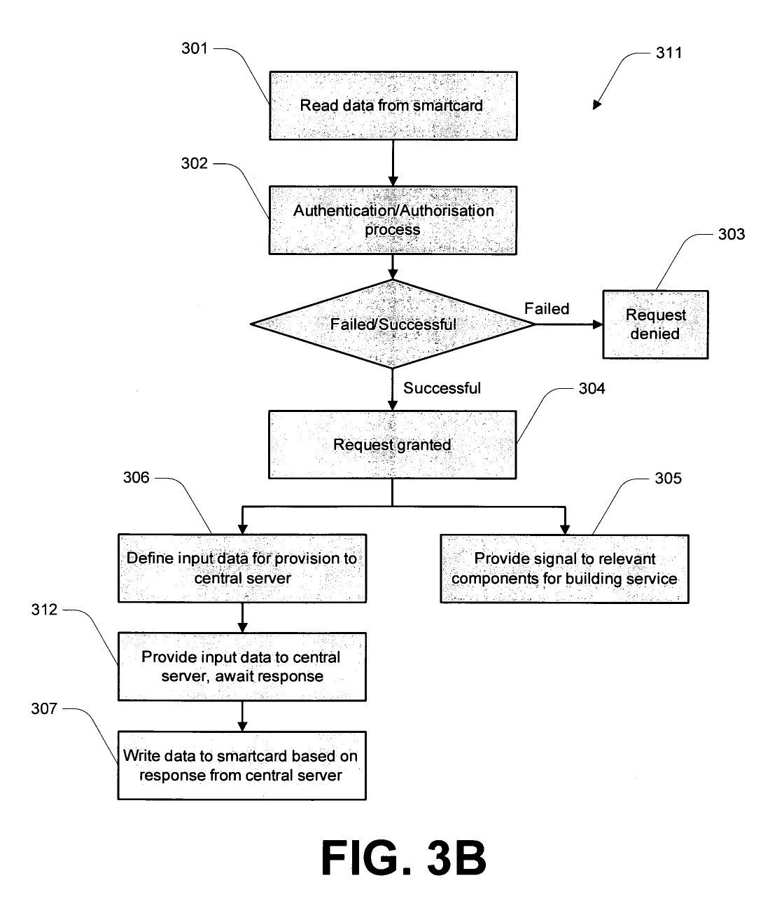

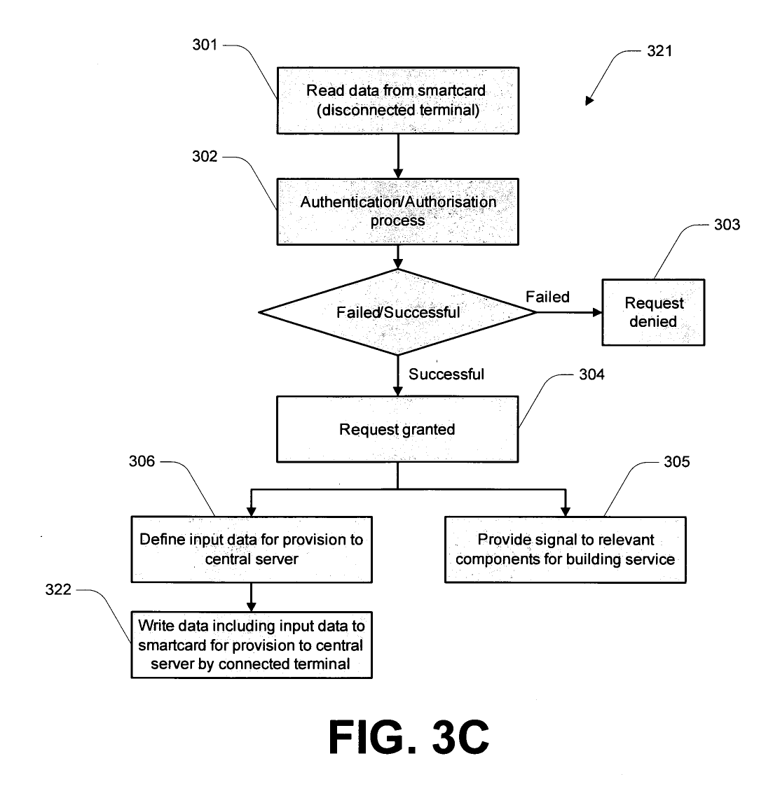

FIG. 3A illustrates an exemplary method 300 performable by terminal 201 on the basis of software instructions 204 for providing access to a building service. Step 301 includes reading data from a smartcard. Step 302 includes an authentication/authorization procedure to determine whether the smartcard (and, at least in theory, the holder of that smartcard) is able to be successfully authenticated, and whether it possesses the necessary level of authorization to access the controlled functionality. In the event that the authentication/authorization fails, the method progresses to 303 where the request is denied. In the event that the authentication/authorization is successful, the method progresses to 304 where the request is granted.

Following step 304, method 301 progresses to steps 305, 306 and 307. These are shown as being performed in parallel, although in some embodiments they are performed sequentially. Step 305 includes providing a control signal to one or more hardware components associated with the provision of the relevant service (such as a signal to a POS terminal to indicate that a payment is successfully made, or a signal to a lighting controller to activate one or more lights). Step 306 includes defining input data for provision to the central server to allow the performance of method 100. Step 307 includes writing data indicative of the granted request to the smartcard. For example, in some embodiments the smartcard carries a credit amount, and this is decreased at step 307 to account for an attributable building service cost.

FIG. 3B illustrates a further method 311. Method 311 progresses from step 306 to step 311 where the input data is transmitted over a TCP/IP network to the central server. Step 307 is then performed based on data received from the central server in response.

FIG. 3C illustrates a further method 321, intended for a disconnected terminal. Method 311 progresses from step 306 to step 322, where the input data is written to the smartcard such that it is able to be subsequently read and transmitted to the central server when that smartcard is presented to a connected terminal.

### System Level Functionality

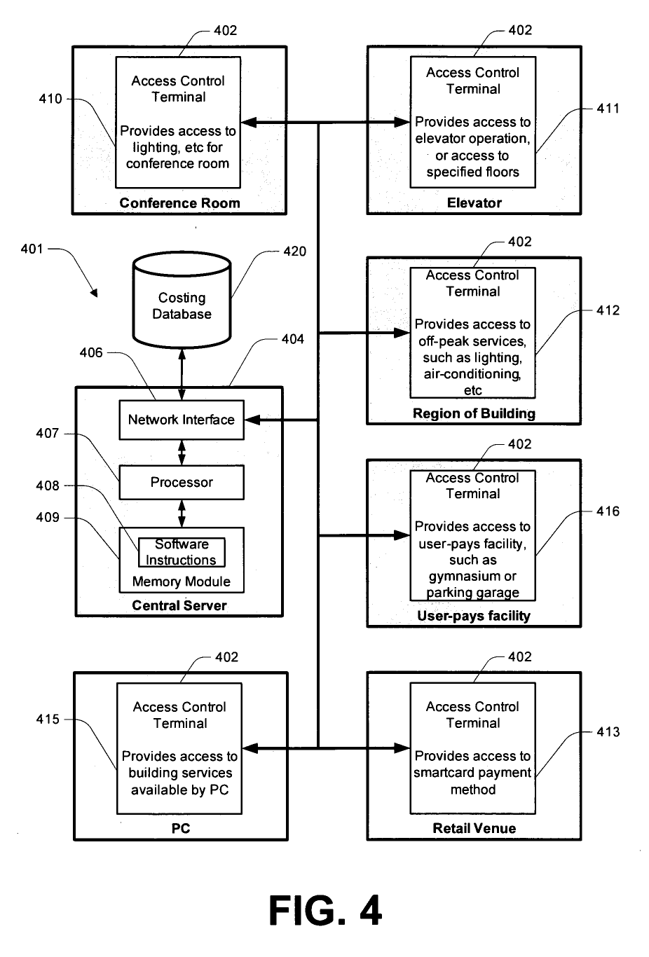

FIG. 4 illustrates a system 401 for managing building services according to one embodiment. System 401 includes a plurality of access control terminals 402, which might include both connected and disconnected terminals. Terminals 402 communicate with a central server 404, for example via a TCP/IP network (noting that, for disconnected terminals, connection to such a network might be intermittent or indirect, for example by way of smartcard communication between the disconnected terminal and a connected terminal). Central server 404 includes a network interface 406 for the purpose of such communications. Furthermore, the server includes a processor 407 for executing software instructions 408 maintained on a memory module 409. The execution of these software instructions allows server 404 to perform various functionalities, including the performance of method 100.

System 101 provides for management of a plurality of building services. Each building service is accessed by way of a respective access control terminal. These terminals and their building services are discussed below.

Terminal 410 provides functional access to a building service in the form of a conference room. In this example, terminal 410 is provided on an internal wall of the conference room. A user wishing to make use of the conference room inserts his/her smartcard into terminal 410 and, assuming the resulting request is granted, lighting is provided to the room for a predetermined period of time (optionally one hour). At the end of the period the lighting is terminated, and the user presents his/her smartcard once again to obtain an additional hour of use. In some instances additional functions other than lighting are provided, such as air conditioning. In some embodiment the air-conditioning does not terminate immediately at the end of the period, and instead provides a grace period to reduce power consumption associated with unnecessarily deactivating and reactivating air-conditioning over a short period of time.

Terminal 411 provides access to an elevator. In this example, terminal 411 is provided either externally of the elevator or within the elevator. A user wishing to make use of the elevator inserts his/her smartcard into terminal 411 and, assuming the resulting request is granted, the user is able to travel by way of the elevator.

Terminal 412 provides off-peak services to a region of the building. In some cases terminal 412 is a generally conventional access control terminal used to gain access to that region of the building. In other embodiments it is more similar to terminal 410, and more closely resembles a wall-mounted light switch

Terminal 413 provides access to a payment method for a retail venue. In this case, terminal 413 is coupled to or used in conjunction with a POS terminal to allow a user to pay for goods and/or services by way of a smartcard (which may be linked to a credit card or other existing payment means). In overview, a user provides a smartcard to terminal 413 to pay for goods and/or services. In the event that the resulting request is granted, terminal 413 provides a signal to the POS terminal indicating that payment has been made, much in the same manner as a conventional EFTPOS terminal interacts with a POS terminal. In such embodiments the data indicative of the granted request is also indicative of a payment amount.

Terminal 415 provides access to services available over a network via a PC. For example, terminal 415 is integrated with a PC, or coupled to a PC (for example a USB smartcard reader). Authorization/authentication for various services available via the computer is archived by way of the smartcard. Examples of such services include access to printers and other output devices, access to a VPN, access to video surveillance feed, access to surveillance monitoring/video analysis functionalities, and so on. This allows building service costs for such services to be defined and appropriately attributed. For example, in one embodiment a component of the costs associated with providing a video surveillance system is passed on to those parties who make use of advanced or resource intensive functionalities (such as live-feed) via a smartcard accessible web-based interface. In some embodiments a smartcard is used to logon to a PC. The PC, as a result of this log on, is configured to provide authentication information from a digital certificate to an appropriate source. For example, in some cases this source is a web browser that provides access to various services by way of a web-browser executing on a client PC. In this manner, it is possible to view the web server as an access control terminal.

Terminal 416 provides access to a user-pays facility, such as a gymnasium, car parking station, or the like. In some cases this terminal is coupled to a turnstile or the like, such that the access granted is a physical access.

Server 404 continually and/or periodically receives data indicative of granted requests from terminals 402, and is responsive to that data for performing a method based on method 100 above. Some more specific examples of methods according to various embodiments are considered further below. However, at a broad level, it will be appreciated that server 404 is able to establish at which terminal a request is granted. In the present example, server 404 operates in conjunction with a costing database 420. This database relates each terminal 404 to costing information to assist in the determination of a business resource cost for a particular granted request. For example, the database associates a granted request of Type A at a Terminal B as having a building service cost of $C. Server 404 then attributes this cost to an appropriate party, as discussed further below.

In some embodiments, rather than maintaining costing information at a centralized location (such as database 420), this information is distributed across the access control terminals themselves. In this manner, the input data received at server 404 is indicative of the building service cost for the relevant granted request, and step 102 includes extracting the data indicative of this cost from the input data.

### Initial Definition of Building Service Costs

In at least some of the presently considered embodiments, building service costs are determined based on previously defined costing information. In overview, this involves initially defining a building service cost that is to be associated with the provision of a particular building service. For example, considering the broad categories of building service provided above, a particular building service might have one or more of the following:

A facility-based services cost. For example, this might be a time-based per-use hire fee for a facility item, such as a conference room or piece of equipment.

An off-peak shared services cost. For example, this might be a premium charge applied for the usage of certain services during off-peak times.

A utility services cost. This is used to account for utility consumption, such as electricity, gas, water, maintenance, and the like.

A consumer services cost, such as the advertised price of particular retail goods and/or services.

For the sake of a specific example, consider a conference room that is shared by four parties on a common floor of a building. Analysis is conducted to determine an appropriate building service cost for the use of this conference room. For the sake of this example, assume that only a utility cost is to be considered (i.e. usage of the conference room does not incur a facility-based service cost, etc). The utility service cost in this example is defined to be a power cost resulting primarily from electricity that is required to provide the room in a usable state (for example, to run lighting, air-conditioning, and the like). This power cost is determined based on empirical evidence (for example meter observation) and/or estimation (for example calculations based on appliance power ratings and the like). From this, it is determined that the utility cost is $X for a given unit of time (this $X optionally including a service charge, markup or buffer). For the sake of the present example, we shall assume that the unit of time is one hour.

Continuing with this example, an access control terminal is placed in or nearby the conference room to control operation of the room, which essentially means that it controls the lighting, air-conditioning, etc. A smartcard is provided to this terminal to request usage of the conference room and, assuming the request is granted, the terminal is configured to allow operation of the room (i.e. activate the lighting, air-conditioning, etc) for a predetermined period of time. For the sake of simplicity in the present example, assume that the predetermined period of time is one hour. In this manner, the access control terminal has been configured in a manner such that a granted request corresponds to a building service cost of $X. This cost is able to be attributed to an appropriate party, as discussed further below.

In some embodiments the above exemplary building service cost might also include a utility cost in the form of a maintenance cost, relating to the cost of having someone clean and reset the room after use. It will be appreciated that such a cost is not time dependent, but use dependent.

The above example deals with an instance where a building service cost has a predetermined quantum. In some embodiments the building service cost is instead based on an apportionment of overall costs. For example, in another example a building service relating to a conference room as described above includes a component of facility-based service cost determined in this manner. This facility cost is based on a monthly rental cost for the conference room, (for instance based on floor space). This monthly rental cost is shared among the parties who share the conference room based on actual usage. In one case, each party is charged a like opportunity cost to cover the opportunity to use the meeting room. Each party is also charged a usage cost, such that the remainder of the monthly rental cost is shared among the parties based on actual usage. The relevant calculation is made at the end of a monthly period by processing all granted requests at the relevant terminal, determining which party was responsible for each request, and apportioning accordingly.

It will be appreciated that the concept of apportionment is particularly applicable to off-peak shared services. In this manner, the cost of off-peak shared services is more heavily subsidized by those who use such services the most.

### Attributing Building Service Costs

As noted above, step 103 includes attributing the building service cost to a party associated with the granted request. This necessarily requires a determination be made regarding the party to whom the cost is to be attributed. The manner in which this occurs in various embodiments is discussed further below.

Generally speaking, attribution determinations are made based on either or both of data associated with the terminal and data associated with the user (i.e. the smartcard). Several examples are considered below.

In some embodiments a particular access control terminal is associated with a given party. In such cases, business resource costs for any requests granted at that terminal are attributed to that party.

In some embodiments a smartcard is associated with a user account, and business resource costs for requests granted to that smartcard are attributed to the user account.

In some embodiments a smartcard is associated with a business account, and building resource costs for requests granted to that smartcard are attributed to the business account.

In some embodiments a smartcard is associated with a user account and a business account, and business resource costs for requests granted to that smartcard are attributed to the user account or the business account. Which of these is applicable depends on the nature of the service, and is in some embodiments determined by one or more characteristics of the access control terminal being used. For example, some access control terminals are configured for dealing with business expenses, such as the usage of conference rooms, whilst other access control terminals are configured for dealing with personal expenses, such as the purchase of items from a vending machine.

In the above examples, the association might be contained in the smartcard/terminal itself, or in a data store coupled to the central server. It will be appreciated that the former is more conducive to the implementation of attribution at the server side, whilst the latter allows for implementation of attribution at the server side or the terminal side.

The practical effect of attribution varies between embodiments. Several example are considered below.

In some cases, one or more building service costs attributed to a given party are invoiced to that party on a periodic basis.

In some cases one or more building service costs attributed to a given party are totaled at the end of a given period, and any amount exceeding a predetermined threshold is invoiced to that party.

In some cases one or more building service costs attributed to a given party are totaled at the end of a given period, and the total is used to optionally modify future charges for an upcoming period. That is, charging is not retrospective; rather the approach is to periodically adjust charging based on past usages.

In some cases a prepaid credit system is used, whereby a party has a prepaid credit amount, which is reduced as building service costs are attributed to that party.

Combination approaches. For example, in some cases personal expenses are covered using prepaid credit, and business expenses covered by other means.

It will be appreciated that there are many other techniques for performing useful accounting once building service costs have been attributed to an appropriate party.

### Exemplary Methods

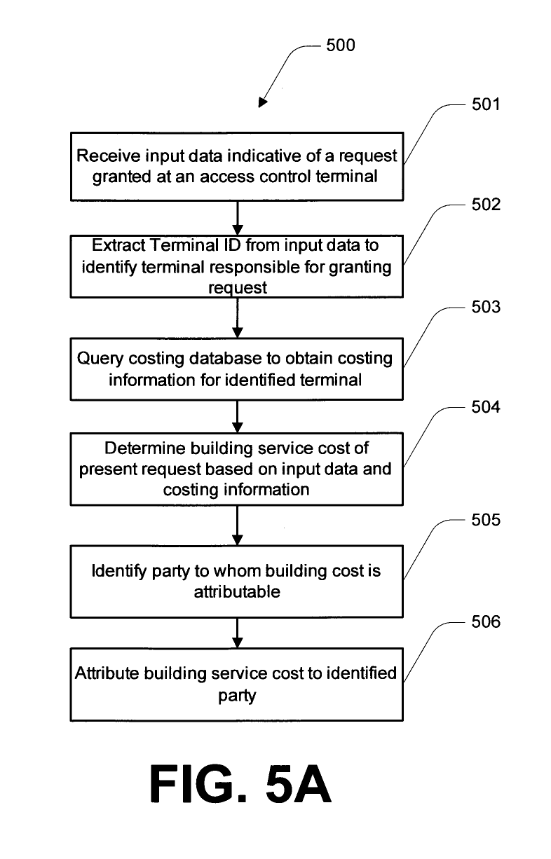

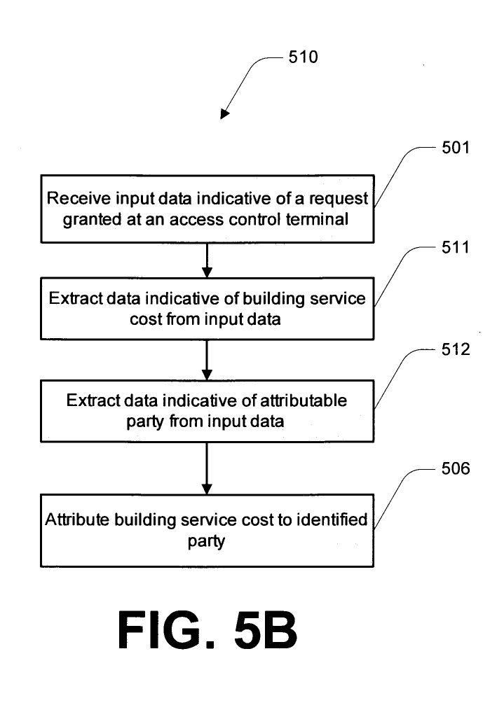

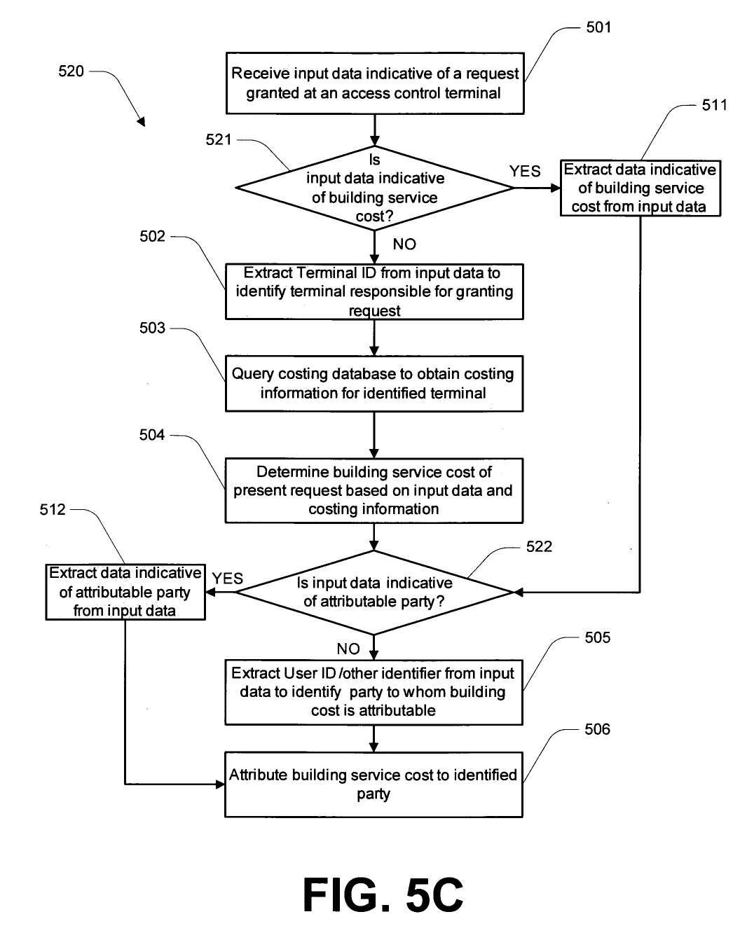

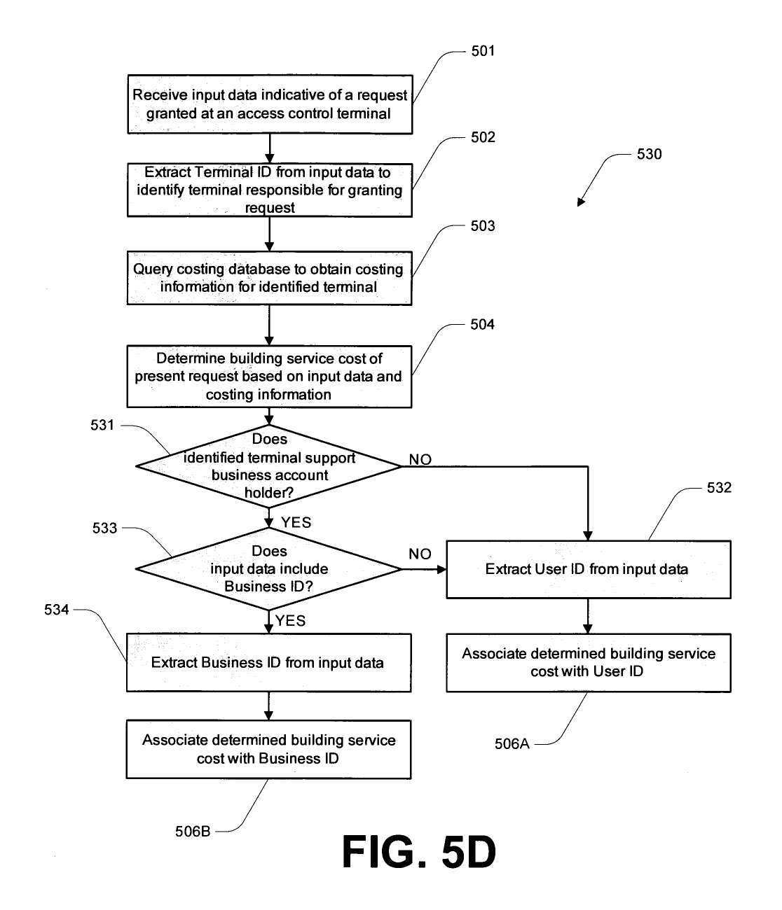

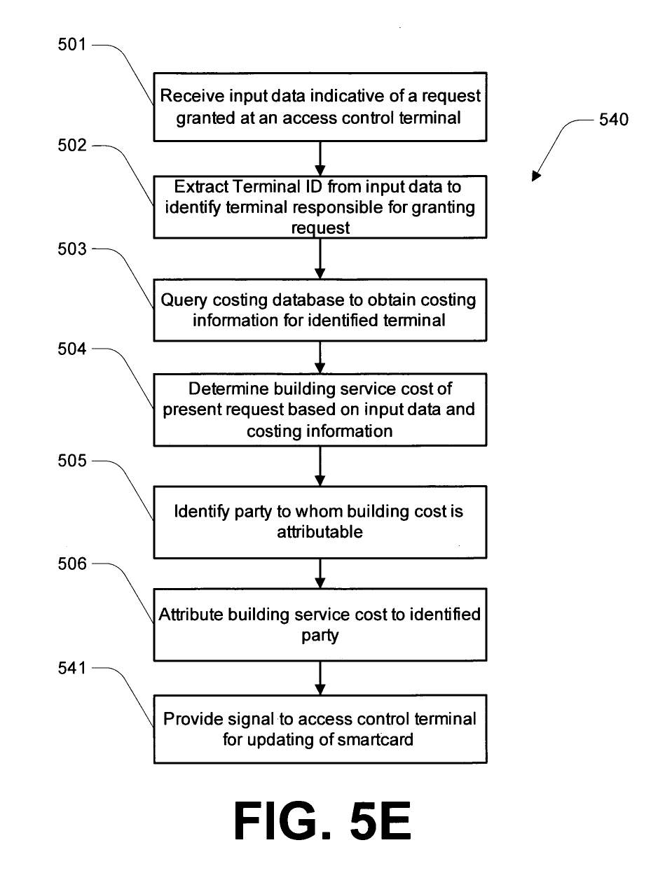

As noted above, in the context of system 401, server 404 continually and/or periodically receives data indicative of granted requests from terminals 402, and is responsive to that data for performing a method based on method 100 above. Some more specific examples of such methods according to various embodiments are considered below by reference to FIG. 5A to FIG. 5E. In these figures, like steps are identified by like reference numerals.

FIG. 5A illustrates a method 500. In this method, step 501 includes receiving input data indicative of a request granted at an access control terminal. This is presently received over a TCP/IP network, although not necessarily from the terminal responsible for granting the request (for example where that terminal is a disconnected terminal). Step 502 includes extracting a Terminal ID from the input data to allow identification (either uniquely or based on a class or type) of the terminal responsible for granting the request. Step 503 includes querying a costing database to obtain costing information for the identified terminal. This costing information is processed at 504 in conjunction with none or more further aspects of the input data to determine a building service cost. A party to whom this cost is attributable is identified at 505, and attribution performed accordingly at 506.

In the context of method 500, it is presumed that server-side processing of the input data in light of a costing database is required to allow determination of a building service cost. However, in other embodiments the input data is in itself indicative of such a cost. For example, in some embodiments costing information is distributed among the terminals themselves, rather than being maintained in a central database. Additionally, in some cases the input data necessarily must include data indicative of a cost, for example where a retail purchase is made by way of smartcard payment. FIG. 5B illustrates a method 510 in such a vein. This method includes extracting data indicative of a building service cost and attributable party, respectively at steps 511 and 512.

FIG. 5C illustrates a hybrid of methods 500 and 510, in the form of method 520. In this method, decisions 521 and 522 determine whether the steps of method 500 or 510 are implemented for the purposes of cost determination and attributable party identification respectively.

FIG. 5D illustrates a method 530, which illustrates an exemplary implementation of user/business accounts. Following step 504, the method considers at 531 whether the terminal in question supports business account holders. To this end, it is assumed that some terminals are configured for business purposes (for example those provided for accessing elevators and activating conference rooms), and others for personal purposes (for example those provided for making retail purchases). If the terminal is not configured to support business account holders, the method progresses to step 532, where a User ID is extracted from the input data to allow attribution at step 506A.

If the terminal is configured to support business account holders, the method progresses to decision 533, where it is considered whether the input data includes a Business ID (or, in some embodiments, whether the User ID is associated with a Business ID). Where possible, the Business ID is extracted at 534 and used for attribution at 506B. Other wise, the method progresses to 506A via 532.

It will be appreciated that the approach of method 501 allows smartcards to be provided to parties other than businesses in the relevant building such that services may essentially be provided (at a cost) to outsiders.

FIG. 5E illustrates a method 540, which is similar to method 500 but for an additional set 541 including providing a signal to the access control terminal for allowing the updating of a smartcard at the terminal side. It will be appreciated that this allows the smartcard to be updated based on server side determinations. In some cases this updating includes reducing a stored level of prepaid credit.

It will be appreciated that the present method are provided as examples only to illustrate various procedures and functionalities. Combinations and/or modifications of these methods are implemented in further embodiments.

### EXAMPLE

### Attributing Costs of Shared Building Resources between User Groups

A further example is described below, in terms of attributing the costs of shared building resources for a building between a plurality of user groups. For example, the user groups might be tenants, non-tenant users, business departments, or the like.

In this example, access control devices are installed at locations within the building. These devices are configured for controlling access to respective shared building resources, this being functional access rather than physical access. It is assumed that the same sorts of devices are used for physical access purposes in the building. In this manner, a user undergoes a similar procedure for gaining physical access to parts of the building as for gaining functional access to shared building services.

For the sake of the present example, the access control devices are smartcard enabled devices, and receive access requests based upon the presentation of smartcards (optionally in combination with biometric or other complementary information). Other devices may be used, and examples are considered elsewhere in the present specification. In this case, a user is issued with a smartcard that allows for gaining physical access to parts of the building and for gaining functional access to shared building services.

In a conventional scenario, an access control device is configured for controlling physical access to a location, for example in terms of unlocking a door, allowing for an elevator to be called, and so on. This is contrasted with providing functional access to a shared building resource. By way of a simple example, consider a meeting room. Providing physical access to that meeting room might occur by way of an access control device at door of the room. However, this physical access does not allow the room to be used functionally. Rather, gaining functional access to the room requires, for example, lighting to be activated in the room. In some cases air conditioning and other powered services are also provided for functional access. The access control devices considered in the present example are configured to provide such functional access. For example, the devices are coupled to lighting controllers and the like, and provide control signals to those devices subject to the access requests in the event that functional access is to be granted (for example subject to an authentication/authorization procedure conducted in respect of a user-submitted access request).

Each access request is indicative (directly or by association) of a user group identifier for allowing identification of a user group to which a given access request is attributable. That is, a smartcard might carry data directly indicative of a user group identifier (i.e. such an identifier is able to be determined simply by reading the smartcard). A smartcard might alternately be indicative of a user group identifier by association (i.e. the smartcard carries data that is elsewhere associated with a user group identifier, for example in a central database). In the case of the latter, in some cases, smartcard carries an alternate identifier, such as an individual user identifier or a card identifier, which is associated with the user group identifier in a database (local or remote). It is by no means necessary that the user group identifier be determined at the time of processing the access request; this may occur at a later stage in the overall cost attribution process.

Each access request is processed, for example subject to an authentication/authorization procedure (which may be conducted either locally, remotely, or at a combination of local and remote locations). Access is selectively granted; access is granted following successful authentication and authorization. For the present purposes, the term “instance of access” is used to describe an event where functional access is granted in respect of a shared building resource. That is, a user presents a smart card, and subject to approval via the authentication/authorization procedure, is granted an “instance of access” to the shared building resource. Upon granting is an instance of access, the access control device provides one or more control signals thereby to provide the relevant functional access (for example lighting in a meeting room is activated for a predetermined period of time).

A central database maintains data received from access control devices. This data may be received directly over a network, or by various other back-propagation techniques (for example where an access control device is not connected to a network over which it can communicate with the central database). The maintained data includes data indicative of instances of access to the shared building resources. Each instance of access is associated with the user group identifier for the causal access request (i.e. the access request provided which resulted in the instance of access). This in some cases occurs in a relational database system. In one example, a user (or automated process) is able to query the database in terms of a particular building resource, and determine the number of instances of access granted to each user group (and optionally additional information, such as the times at which those instances were granted, individual users responsible, and so on).

The central database is used to assist in the attribution of costs. More particularly, on the basis of the data indicative of instances of access to the shared building resources and the associated user group identifiers, the costs of the shared building resources are attributed between the plurality of user groups. Some exemplary techniques are considered below:

Per-use attribution: This includes, for a given shared building resource, defining a unit cost associated with an instance of access. For each instance of access to that shared building resource, the defined unit cost for that shared building resource is attributed to the user group identified by the associated user group identifier. That is, the predefined unit cost is attributed to user groups on a per-use basis.

Proportional attribution: This includes, for a given shared building resource, defining a periodic overall cost associated with provision of the building resource over a predetermined period. Data processing is conducted in respect of data indicative of instances of access to that shared building resource over the predetermined period, thereby to determine a total number of instances of access to the shared building resource over the predetermined period. The overall periodic cost is proportionally attributed between the user groups based on a comparison between the total number of instances of access and the number of instances of access for which each user group is respectively responsible. For example, assume there were ten instances of access during the predetermined period: eight by a first user group, and two by a second user group. From this, 80% of the overall periodic cost is attributed to the first user group, and 20% of the overall periodic cost is attributed to the second user group.

Specified cost attribution: In some cases an instance of access is associated with a specified cost, determined based on processing at the access control device. That is, when an access control device defined data indicative of an instance of access, it associates that instance with a specified cost. For example, a single access control device may be configured to provide access to multiple shared building services, having different costs, or a single service having varied costs (for instance based on time).

In determining costs for any of the above scenarios, regard may be given to a number of factors, such as the actual cost of an instance of use (in terms of power consumption, etc), and/or a predefined usage price. In broad terms, cost determinations may be set on substantially any grounds (including arbitrary grounds). Furthermore, costs need not be financial in nature. Rather, in some cases the present arrangement is used to evaluate the utilization of resources, without a view to financial implications or recovering financial costs. An example is to consider departments within an organization, and determine their relative profitability in terms of the extent to which they each use shared resources.

In some embodiments, costs are able to be attributed at a user group level, as discussed above, and additionally at an individual user level. This provides a two-level cost attribution model, optionally allowing for costs to be attributed to user groups as “business costs” and to individuals as “personal costs”. For example, one embodiment provides a food/beverage kiosk, which is regarded as a shared building service. A user wishing to obtain food/beverage from the kiosk uses a smartcard to “pay” for food/beverage (payment is attributed to the individual in a similar manner as to a user group, as described above). This is same smartcard that is used to gain access to parts of the building, or to other shared building services. In some cases a lock/vending machine arrangement is integrated with an access control device for this overall purpose.

### Conclusions

It will be appreciated that the above disclosure deals with various useful systems and method for managing building resources. At a commercial level, these may assist in the likes of revenue generation, equality in charging, and the implementation of green initiatives. In this manner, it becomes relatively straightforward to cerate an economy for transactional building services, both for employees within a building, and for outside parties such as contractors and visitors. Furthermore, various commercial business models will be foreseen. For example, in one implementation the functionalities provided herein are provided by a service provider, this service provider taking a commission from building service costs attributed.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., an liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be includes in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while some diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that are for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media, a medium bearing a propagated signal detectable by at least one processor of one or more processors and representing a set of instructions that when executed implement a method, a carrier wave bearing a propagated signal detectable by at least one processor of the one or more processors and representing the set of instructions a propagated signal and representing the set of instructions, and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A method for attributing the costs of shared building resources for a building between a plurality of user groups, the method including the steps of:
installing a plurality of access control devices at locations within the building;
configuring the access control devices for controlling access to respective shared building resources, wherein the access is functional rather than physical;
receiving, at the access control devices, data indicative of access requests, wherein each access request is indicative of a user group identifier for allowing identification of a user group to which a given access request is attributable;
processing each access request for respectively selectively granting an instance of access to the relevant shared building resource;
maintaining a database including data indicative of instances of access to the shared building resources, wherein each instance of access is associated with the user group identifier for the causal access request; and
on the basis of the data indicative of instances of access to the shared building resources and the associated user group identifiers, attributing the costs of the shared building resources between the plurality of user groups.

2. A method according to claim 1 wherein attributing the costs of the shared building resources between the plurality of user groups includes:
for a given shared building resource, defining a unit cost associated with an instance of access; and
for each instance of access to that shared building resource, attributing the defined unit cost for that shared building resource to the user group identified by the associated user group identifier.

3. A method according to claim 1 wherein attributing the costs of the shared building resources between the plurality of user groups includes:
for a given shared building resource, defining a periodic overall cost associated with provision of the building resource over a predetermined period; and
processing the data indicative of instances of access to that shared building resource over the predetermined period thereby to determine a total number of instances of access to the shared building resource over the predetermined period; and
proportionally attributing the periodic overall cost between the user groups based on a comparison between the total number of instances of access and the number of instances of access for which each user group is respectively responsible.

4. A method according to claim 1 wherein the shared building resources include at least one shared meeting room, and wherein the functional access includes access to lighting in the meeting room.

5. A method according to claim 1 wherein the data indicative of access requests, is inherently indicative of an individual user identifier, and allows identification of a user group based on the association in a database of that individual user identifier with a user group identifier.

6. A computer implemented method for attributing the costs of shared building resources for a building between a plurality of user groups for that building, the method including the steps of:
maintaining data indicative of the configuration of a plurality of access control devices, wherein each access control device is configured for controlling access to a respective shared building resource, wherein the access is functional rather than physical;
receiving, from the access control devices, data indicative of instances of access to the shared building resources, wherein each instance of access is able to be associated with a user group identifier for the causal access request for allowing identification of a user group to which a given access request is attributable; and
on the basis of the data indicative of instances of access to the shared building resources and the associated user group identifiers, attributing the costs of the shared building resources between the plurality of user groups.

7. A method according to claim 6 wherein attributing the costs of the shared building resources between the plurality of user groups includes:
for a given shared building resource, defining a unit cost associated with an instance of access; and
for each instance of access to that shared building resource, attributing the defined unit cost for that shared building resource to the user group identified by the associated user group identifier.

8. A method according to claim 6 wherein attributing the costs of the shared building resources between the plurality of user groups includes:
for a given shared building resource, defining a periodic overall cost associated with provision of the building resource over a predetermined period; and
processing the data indicative of instances of access to that shared building resource over the predetermined period thereby to determine a total number of instances of access to the shared building resource over the predetermined period; and
proportionally attributing the periodic overall cost between the user groups based on a comparison between the total number of instances of access and the number of instances of access for which each user group is respectively responsible.

9. A method according to claim 6 wherein the shared building resources include at least one shared meeting room, and wherein the functional access includes access to lighting in the meeting room.

10. A method according to claim 6 wherein the data indicative of access requests, is inherently indicative of an individual user identifier, and allows identification of a user group based on the association in a database of that individual user identifier with a user group identifier.

11. A system for attributing the costs of shared building resources for a building between a plurality of user groups for that building, the system including:
a plurality of access control devices installed at locations within the building, wherein the access control devices are configured for controlling access to respective shared building resources, wherein the access is functional rather than physical, wherein controlling access to respective shared building resources includes, for a given device:
(i) receiving, at the access control devices, data indicative of an access request, wherein the access request is indicative of a user group identifier for allowing identification of a user group to which the access request is attributable; and
(ii) in response to the access request, selectively granting an instance of access to the relevant shared building resource;
a database for maintaining data indicative of instances of access to the shared building resources, wherein each instance of access is associated with a user group identifier for the causal access request; and
a computer system for, on the basis of the data indicative of instances of access to the shared building resources and the associated user group identifiers, attributing the costs of the shared building resources between the plurality of user groups.

12. A system according to claim 11 wherein attributing the costs of the shared building resources between the plurality of user groups includes:
for a given shared building resource, defining a unit cost associated with an instance of access; and
for each instance of access to that shared building resource, attributing the defined unit cost for that shared building resource to the user group identified by the associated user group identifier.

13. A system according to claim 11 wherein attributing the costs of the shared building resources between the plurality of user groups includes:
for a given shared building resource, defining a periodic overall cost associated with provision of the building resource over a predetermined period; and
processing the data indicative of instances of access to that shared building resource over the predetermined period thereby to determine a total number of instances of access to the shared building resource over the predetermined period; and
proportionally attributing the periodic overall cost between the user groups based on a comparison between the total number of instances of access and the number of instances of access for which each user group is respectively responsible.

14. A system according to claim 11 wherein the shared building resources include at least one shared meeting room, and wherein the functional access includes access to lighting in the meeting room.

15. A system according to claim 11 wherein the data indicative of access requests, is inherently indicative of an individual user identifier, and allows identification of a user group based on the association in a database of that individual user identifier with a user group identifier.

16-20. (canceled)
